(19) United States
(12) Patent Application Publication
(10) Pub. No.: US 2007/0289217 A1
(43) Pub. Date: Dec. 20, 2007

(54) Overhead door cable assembly with molded cable stop

(75) Inventor: Harold Elmer Gall, Worthington, OH (US)

Correspondence Address: MARSHALL & MELHORN, FOUR SEAGATE, EIGHT FLOOR, TOLEDO, OH, 43604, US

(73) Assignee: ARROW TRU-LINE, INC

(21) Appl. No.: 11/803,043

(22) Filed: May 11, 2007

Related U.S. Application Data
(60) Provisional application No. 60/801,276, filed on May 18, 2006.

(51) Int. Cl. E05F 11/38

(52) U.S. Cl. 49/323

(57) ABSTRACT

An overhead door cable assembly includes a length of cable having first and second ends and a metal stop permanently molded proximate the first end of the length of cable. A molded metal stop, preferably formed of aluminum, may be secured at both ends of the cable. An overhead door cable assembly may be formed by a method that comprises providing a length of cable having first and second ends and positioning a portion of the length of cable proximate to the first end into a mold cavity. A molten metal material, preferably aluminum, is introduced into the mold cavity and allowed to cool, thereby forming a metal stop permanently molded to the cable. The overhead door cable assemblies of the invention may be utilized in a method of counterbalancing an overhead door.

### RELATED APPLICATION

This application is claiming the benefit, under 35 U.S.C. § 119(e), of the provisional application filed May 18, 2006 under 35 U.S.C. § 111(b), which was granted Ser. No. 60/801,276. This provisional application is hereby incorporated by reference.

### BACKGROUND OF THE INVENTION

The invention relates to overhead doors and, more particularly, to a cable end stop for an overhead door, such as a residential garage door, cable assembly. The invention further relates to a method of forming an overhead door cable assembly and method of counterbalancing an overhead door.

Overhead doors are well-known and are used as closures for large openings such as garage and warehouse entrances. The overhead door is configured as a plurality of horizontally oriented, elongated sections hingedly joined along adjacent edges to form the vertical door. The ends of the sections are movably mounted in vertical tracks at each edge of the large opening. The upper ends of the tracks curve interiorly to a horizontal position so that when the overhead garage door is opened, it is raised vertically into an elevated, horizontal position inside the enclosure. In this manner, the overhead garage door is suspended overhead and out of the way when it is open to its fullest extent, thereby leaving a relatively unobstructed entrance to the garage, warehouse, or the like.

From the foregoing, it is clear than an overhead garage door of any significant size will be quite heavy to lift vertically from its closed position to the horizontal, open position. Accordingly, it is customary to mount a counterbalancing apparatus or the like to assist the operator in raising and lowering the overhead door between the closed and opened positions. A properly counterbalanced door may be raised and lowered with only a force sufficient to overcome the rolling friction of the rollers attached to the door.

In general, there are two types of counterbalancing assemblies used to aid in lifting overhead sectional doors. The first type is known as a torsion spring system. It typically involves a single steel shaft mounted to the header of the door opening. One or more torsion springs are slipped over the ends of the shaft and abut a fixed central anchor bracket at their inner ends. The free end of each spring is then connected with a winding plug slipped onto the shaft. A winding rod is used to turn the plug and wind the spring. The plug is then secured to the shaft with set screws. A cable drum is mounted at each end of the shaft. A cable is secured to each drum and extends down to the base of the door, to which it is attached. The door is pulled down to a closed position. When the door is raised, the spring or springs unwind, turning the shaft and causing the cables to roll up on the drums, thereby lifting the door.

The second type of lifting assembly is known as an extension spring system, which commonly involves mounting two extension springs, one on each side of the door, usually just above the horizontal track, perpendicular to the closed overhead door. Each spring is anchored at one end to a bracket, commonly secured to the ceiling of the building structure, while the opposite end of the extension spring is affixed to a movable pulley. A second pulley is fixed proximate the top of the door opening frame. A cable is anchored at one end to a bracket proximate the top of the door opening frame. Its free end passes around the pulleys, extends down the length of the door and is attached at its lower end to the door, typically to the corner bracket. When the door is raised, the two springs contract and each spring pulley pulls up on its cable, which assists with the raising of the door.

Thus, each type of overhead door counterbalancing assembly utilizes a pair of cable assemblies, each having a length of cable with a first end affixed to a bracket at the bottom of the door and second end affixed to either a cable drum or a stationary mounting bracket. An appropriately configured end stop is provided at each end of the cable to securely fix the cable end in position. Conventionally, a metal end stop is crimped onto the cable end, either manually or by means of an automated crimping machine.

A problem with overhead doors utilizing counterbalancing spring mechanisms is the potential damage and/or injury resulting from failure of the crimped cable end stop while the extension spring or torsion spring is under tension. It would therefore be desirable to provide an overhead door cable assembly having an improved cable end stop resulting in a stronger and more reliable attachment to the cable end, thereby providing a more secure attachment of the cable assembly to the mounting structures.

Overhead doors may also be equipped with a lock having a handle, the handle commonly being mounted at the center of the door. Rotation of the handle controls latching or locking devices located at the sides of the doors via spring loaded latch catches and similar devices. As is well known, the handle mechanism may be attached to the latches by a cable assembly provided with a cable end stop at each end. It would also be desirable to provide an overhead door lock activating cable assembly with an improved cable end stop resulting in a stronger and more reliable attachment to the cable end.

### SUMMARY OF THE INVENTION

The invention provides an overhead door cable assembly comprising a length of cable having first and second ends and a metal stop permanently molded proximate the first end of the length of cable. In some preferred embodiments, a molded metal stop is secured at both ends of the cable. The cable is preferably formed of steel, while the molded stop or stops are preferably aluminum.

In another aspect of the invention, a method of forming an overhead door cable assembly comprises providing a length of cable having first and second ends and positioning a portion of the length of cable proximate to the first end into a mold cavity. A molten metal material, preferably aluminum, is introduced into the mold cavity and allowed to cool, thereby forming a metal stop permanently molded to the cable.

The invention is also directed to a method of counterbalancing an overhead door utilizing an overhead door cable assembly comprised of a length of cable having first and second ends and a metal stop permanently molded proximate the first end of the cable.

### DESCRIPTION OF THE DRAWINGS

The advantages of the invention will become readily apparent to those skilled in the art from the following detailed description of a preferred embodiment when considered in the light of the accompanying drawings, in which:

FIG. 1 is a perspective view of an overhead door assembly with torsion spring counterbalance system and overhead door cable assemblies in accordance with the invention.

FIG. 2 is a view, partially in cross section, of the end of the cable assembly shown in FIG. 1.

FIG. 3 is a side view of the end of a cable assembly shown in FIG. 1 as secured to a cable drum.

FIG. 4 is a view, partially in cross section, of the other end of the cable assembly shown in FIG. 1.

FIG. 5 is side view of the end of a cable assembly shown in FIG. 5 as secured to a bottom corner bracket.

FIG. 6 is a perspective view of an overhead door assembly with extension spring counterbalance system and overhead door cable assemblies in accordance with the invention.

### DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

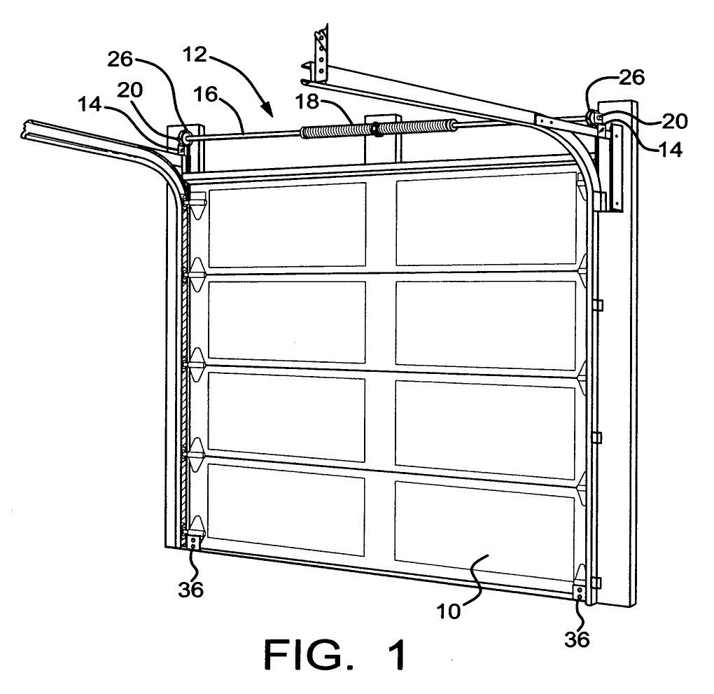

Referring now to FIG. 1 of the drawings, an overhead door assembly is illustrated having a sectional door 10 and a torsion spring counterbalance system denoted generally at 12. The torsion spring counterbalance system 12 includes overhead door cable assemblies 14 formed in accordance with the invention. Other than the overhead door cable assemblies 14, the overhead door assembly is conventional and well known to those skilled in this art.

As shown in FIG. 1, the torsion spring counterbalance system 12 includes an elongate torsion tube 16 having one or more torsion springs 18 thereabout, the torsion tube 16 extending between a pair of end bearing supports 20. Typically, a center bearing support 24 is also provided to support the torsion tube 16. A cable drum 26 is positioned on the torsion tube 16 proximate each end thereof, each drum 26 being mounted for rotation with the torsion tube 16. The cable drums 26 are each provided with an overhead door cable assembly 14 that includes a length of cable 30 wrapped about the drum 26. One end 32 of the cable 30 is securely affixed to the drum 26, while the other end 34 of the cable 30 is securely affixed proximate the bottom of the door 10, such that rotation of the cable drum 26 operates to open or close the door in the conventional fashion. As shown, the end 34 of the cable 28 is secured to the bottom corner bracket 36 on the door 10. It will be appreciated by persons skilled in the art that the overhead door cable assemblies 28 of the invention could be employed with a variety of overhead door torsion spring counterbalance systems, as well as various extension spring counterbalance systems, such as the embodiment described hereafter.

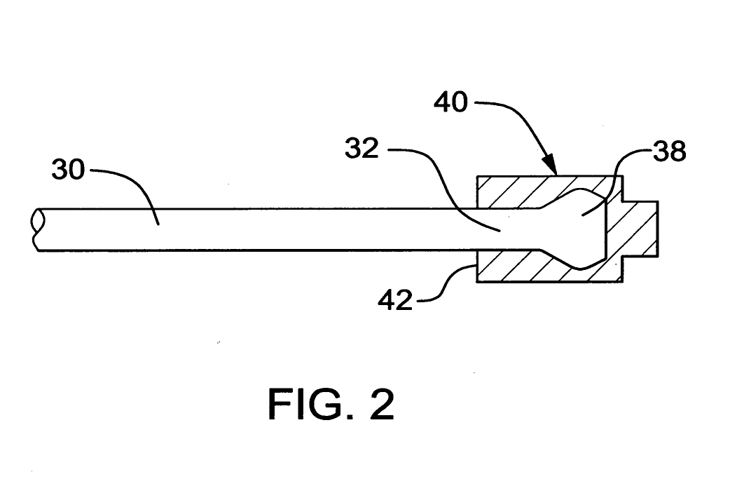

The end 32 of the cable 30 is shown in greater detail in FIG. 2. The cable 20 is formed of a high strength metal material, and is preferably formed of steel, most preferably stainless steel cable. The cable end 32 is preferably formed so as to have a tip 38 of increased diameter relative to the adjacent portion of the cable 30. The enlarged tip 38 may be formed by any suitable means, such as by positioning the cable end 32 in a fixture and mechanically deforming the end.

An end stop 40 is formed about the cable end 32 by means of a molding operation. The cable end 32 is positioned in a mold, with the interior surfaces of the mold and the desired portions of the cable end 32 defining a mold cavity. A molten metal material is introduced into the mold cavity and allowed to cool, thereby forming the permanently attached, one-piece molded end stop 40. The metal used to form the end stop 40 should melt at a temperature below that which would cause significant damage to the portion of the cable 30 housed within the mold cavity during the molding operation. The molded end stop 40 is preferably comprised primarily, and most preferably entirely, of aluminum. Molding of the end stop 40 about an enlarged portion of the cable 30, such as the deformed tip 38, provides for a more secure attachment between the cable 30 and end stop 40.

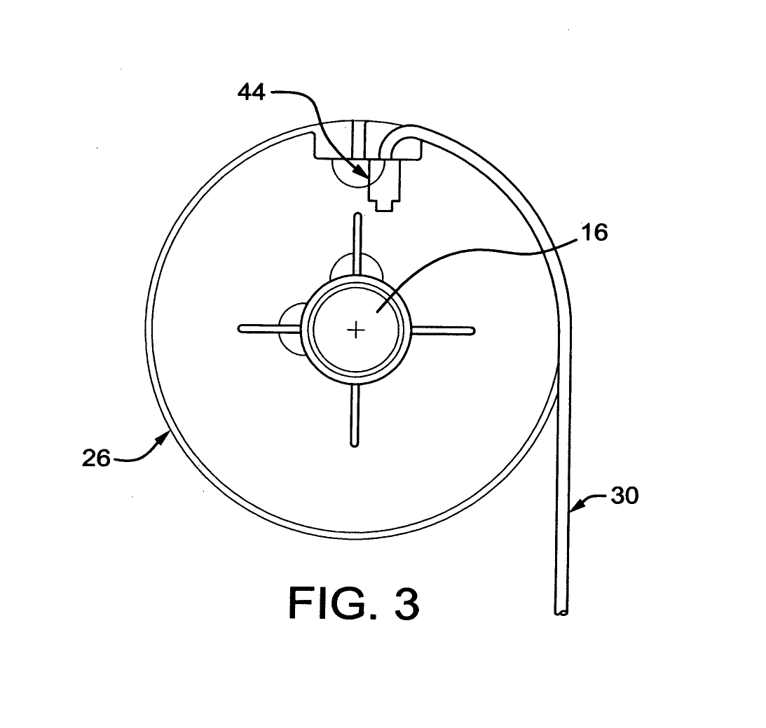

The end stop 40 can of course be molded into various desired shapes using molds having mold cavities of the desired shape. It is important for the molded end stop 40 to include some portion, such as the annular shoulder 42, with an increased radial dimension relative to the adjacent portion of the cable 30. This portion of the end stop 40 acts as a positive mechanical stop when abutting a complementary surface of, for example, a cable drum 26. The end stop 40 may preferably be molded to the same shape as the conventional crimped end stops, allowing use of the overhead door cable assemblies of the invention with existing cable drum designs, as illustrated in FIG. 3.

The other end 34 of the cable 30 is securely affixed proximate the bottom of the overhead door 10. This end is commonly formed into a loop 46 and held there by an end stop or loop stop 44. As mentioned, in the conventional overhead door cable assemblies, a stop is crimped to the cable end. In accordance with a preferred embodiment of the invention, the cable end 34 is bent back so as to form a loop 46 of the desired size, with the cable end 34 abutting a section of the cable 30 in a generally parallel relationship. The cable end 34 and the abutting section of cable 30 cooperate with a mold to define a mold cavity, with the loop 46 positioned outside of the mold cavity. A molten metal material is introduced into the mold cavity and allowed to cool, thereby forming the permanently attached, one-piece molded stop 44. The metal used to form the stop 44 should melt at a temperature below that which would cause significant damage to the portion of the cable 30 housed within the mold cavity during the molding operation. The molded stop 40 is preferably comprised primarily, and most preferably entirely, of aluminum. Molding of the stop 44 about both the cable end 34 and the abutting portion of the cable 30 provides for a secure attachment therebetween. The stop 44 can of course be molded into various desired shapes, including the generally cylindrical collar shown, using molds defining mold cavities of the desired shape.

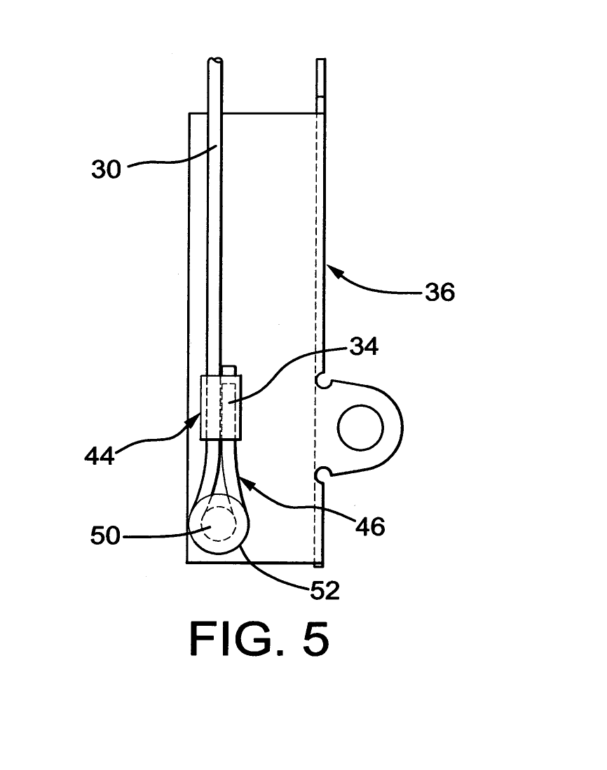

FIG. 5 illustrates the attachment of the cable end 34 of the cable 30 to the bottom corner bracket 36 on the door 10. Typically, the bracket 36 includes a pin 50 that extends outward from the side of the door. The pin 50 is positioned within the loop 46 formed by the cable 34 and stop 44. A radially outwardly extending flange 52 at the end of the pin 50 helps to prevent the cable loop 46 from sliding off of the end of the pin 50.

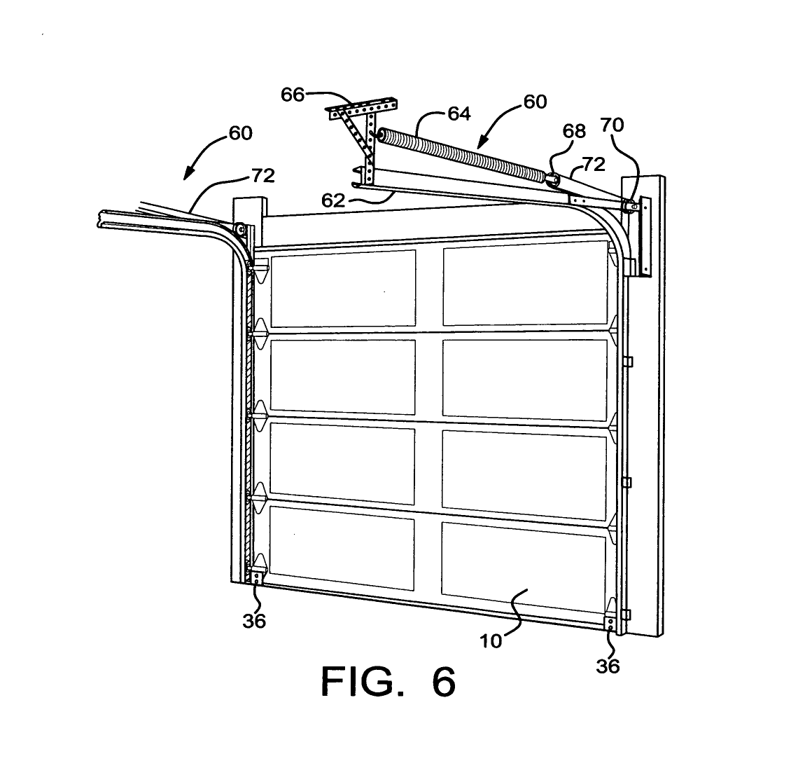

The overhead door cable assemblies 28 of the invention may also be utilized with an overhead door provided with an extension spring system, an example of which is shown in FIG. 6. The illustrated extension spring system includes two extension springs, one on each side of the door, each denoted generally at 60, just above the horizontal track 62, perpendicular to the closed overhead door 10. Each assembly 60 includes an extension spring 64 anchored at one end to a bracket 66 secured to the ceiling of the building structure (not shown), while the opposite end of the extension spring 64 is affixed to a movable pulley or sheave 68. A second pulley or sheave 70 is fixed proximate the top of the door opening frame.

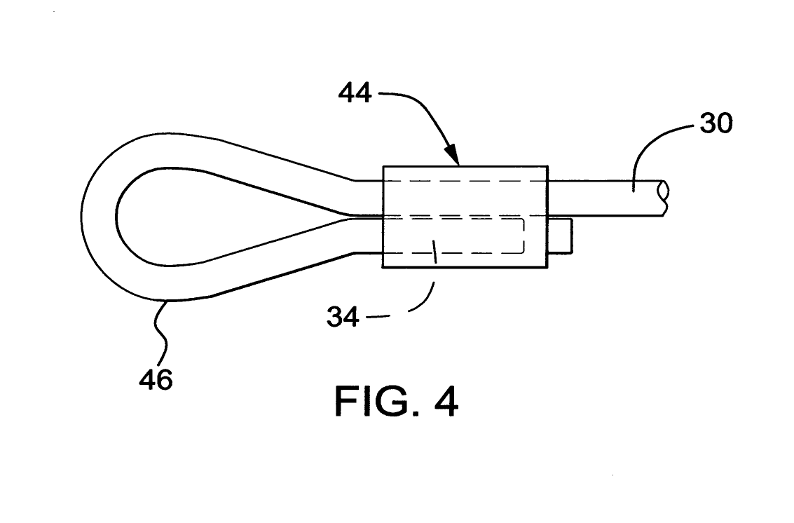

An overhead door cable assembly includes a length of cable 72 that is anchored at one end to a bracket proximate the top of the door opening frame. Its free end passes around the pulleys 68 and 70, extends down the length of the door 10 and is attached at its lower end to the bottom corner bracket 36. Thus, in accordance with this embodiment of the invention, the bottom end of the cable 72 is provided with a loop formed by a molded stop as described above and shown in FIGS. 4 and 5. The opposite or top end of the cable is secured with an adjustable clamp (not shown) as is conventional for an overhead door cable assembly used with an extension spring system. In this application, it is commonly necessary to be able to adjust the length of the cable 72, so that it is not desirable to provide permanent, molded stops at both ends of the cable.

In accordance with the provisions of the patent statutes, the invention has been described in what is considered to represent its preferred embodiments. However, it should be noted that the invention can be practiced otherwise than as specifically illustrated and described without departing from its spirit or scope.

What is claimed is:

1. An overhead door cable assembly comprising a length of cable having first and second ends and a metal stop permanently molded about a section of the length of cable proximate the first end thereof.

2. The overhead door cable assembly of claim 1, wherein the length of cable is comprised of steel.

3. The overhead door cable assembly of claim 1, wherein the length of cable is comprised of stainless steel.

4. The overhead door cable assembly of claim 1, wherein the stop is comprised of aluminum.

5. The overhead door cable assembly of claim 1, further comprising a metal stop permanently molded about a section of the length of cable proximate the second end thereof.

6. The overhead door cable assembly of claim 1, wherein the cable forms a loop adjacent the first end that is permanently secured by the stop.

7. The overhead door cable assembly of claim 1, wherein the first end of the length of cable includes an enlarged tip about which the stop is molded.

8. An overhead door assembly comprising a counterbalancing spring mechanism interconnected with an overhead door panel via a cable assembly, the cable assembly comprising a length of cable having first and second ends and a metal stop permanently molded about a section of the length of cable proximate the first end thereof.

9. The overhead door assembly of claim 8, wherein the counterbalancing spring mechanism comprises a torsion spring.

10. The overhead door assembly of claim 8, further comprising a metal stop permanently molded about a section of the length of cable proximate the second end thereof.

11. The overhead door assembly of claim 8, wherein the counterbalancing spring mechanism comprises an extension spring.

12. The overhead door assembly of claim 8, wherein the length of cable is comprised of steel and the stop is comprised of aluminum.

13. A method of forming an overhead door cable assembly comprising providing a length of cable having first and second ends, positioning a portion of the length of cable proximate to the first end into a mold cavity, and introducing a molten metal material into the mold cavity to thereby form a metal stop permanently molded to the length of cable.

14. The method of claim 13, wherein the length of cable is comprised of steel.

15. The method of claim 13, wherein the length of cable is comprised of stainless steel.

16. The method of claim 13, wherein the stop is comprised of aluminum.

17. The method of claim 13, further comprising deforming the first end of the cable to form an enlarged tip and positioning the tip in the mold cavity prior to molding the stop.

18. The method of claim 13, further comprising positioning a portion of the length of cable proximate to the second end into a mold cavity, and introducing a molten metal material into the mold cavity to thereby form a metal stop permanently molded to the length of cable.

19. A method of counterbalancing an overhead door utilizing an overhead door cable assembly comprised of a length of cable having first and second ends and a metal stop permanently molded proximate the first end of the length of cable.
